(19) United States
(12) Patent Application Publication
(10) Pub. No.: US 2026/0161009 A1
(43) Pub. Date: Jun. 11, 2026

(54) LENS DRIVING DEVICE

(71) Applicant: AAC Microtech (Changzhou) Co., Ltd., Changzhou City (CN)

(72) Inventors: Zhang Ren, Changzhou (CN); Wei Song, Changzhou (CN); Yuhan Wu, Changzhou (CN); Hongbin Chen, Changzhou (CN)

(21) Appl. No.: 19/066,196

(22) Filed: Feb. 28, 2025

Related U.S. Application Data
(63) Continuation of application No. PCT/CN2024/138519, filed on Dec. 11, 2024.

(51) Int. Cl. G02B 27/64; G02B 7/02

(52) U.S. Cl. CPC G02B 27/646; G02B 7/02

(57) ABSTRACT

A lens driving device, comprising: a case, a magnet assembly, a circuit board assembly, an elastic support, a driving coil assembly and an image sensor. The image sensor is opposite to an opening along an optical axis direction. The magnet assembly is opposite to the driving coil assembly to drive the image sensor to move relative to the case. The circuit board assembly includes a first circuit board stacked and fixed to the elastic bracket and a second circuit board connected to the first circuit board. The driving coil assembly is fixed to the first circuit board. The first circuit board is electrically connected to an external circuit by the second circuit board. The first circuit board (PCB) and the second circuit board (FPC) are formed as an integral structure. The lens driving device has a compact structure, space is saved, and an image stabilization driving effect is excellent.

### TECHNICAL FIELD

The present disclosure relates to the technical field of image stabilization, and in particular, to a lens driving device.

### BACKGROUND

With the growing demand for enhanced image shooting experiences, an image stabilization function of a lens driving device has found widespread applications in various imaging devices. The combination of the lens driving device and various portable electronic devices such as mobile phones, cameras, and computers is favored by consumers.

A lens driving device in the related art generally includes a case, a circuit board provided in the case, a magnet or a coil fixed to the circuit board, a coil or a magnet fixed to the case, and a lens bracket fixed to the circuit board. The structural strength of the circuit board is improved by soldering and stacking a plurality of circuit boards. A lens module is fixed to the lens bracket, and the circuit board is elastically supported by means of an elastic piece. When a current is applied to the coil, an electromagnetic field is generated between the coil and a magnet set, and the coil is driven by a Lorentz force of the electromagnetic field to drive the lens bracket to move along a direction perpendicular to an optical axis, thereby driving the lens module to achieve the image stabilization performance. However, in such a lens driving device, the manufacturing cost of the elastic piece that elastically supports the circuit board is relatively high; meanwhile, the lens bracket is supported by soldering and stacking a plurality of circuit boards as a whole, thereby increasing an overall height of the lens driving device, thus resulting in poor space utilization.

In view of this, the present disclosure provides a new lens driving device to solve the above-mentioned technical problems.

### SUMMARY

An object of the present disclosure is to provide a lens driving device with a small overall space, a good driving effect and a better image stabilization effect.

In order to achieve the above-mentioned object, an embodiment of the present disclosure provides a lens driving device, including: a case; a magnet assembly fixed to the case; a circuit board assembly suspended in the case; an elastic bracket supporting the circuit board assembly at the case; a driving coil assembly stacked and fixed to the circuit board assembly and electrically connected to the circuit board assembly; and an image sensor fixed to the circuit board assembly. The case is provided with an opening penetrating through the case along an optical axis direction of the image sensor, the image sensor is opposite to the opening along the optical axis direction, and the magnet assembly and the driving coil assembly are opposite to each other along the optical axis direction, to drive the image sensor to move relative to the case along a direction perpendicular to the optical axis direction. The circuit board assembly includes a first circuit board stacked and fixed to the elastic bracket, and a second circuit board connected to the first circuit board, the driving coil assembly is fixed to a side of the first circuit board facing the magnet assembly, and the first circuit board is electrically connected to an external circuit by means of the second circuit board. The first circuit board is a printed circuit board (PCB), the second circuit board is a flexible circuit board (FPC), and the first circuit board and the second circuit board are formed as an integral structure.

As an improvement, a thickness of the first circuit board is greater than a thickness of the second circuit board.

As an improvement, the second circuit board includes a circuit board body, a flexible extension portion extending from a side of the circuit board body away from the first circuit board, a connection portion bent and extending from two opposite ends of the circuit board body towards the first circuit board, and a fixation portion bent and extending from the connection portion towards the first circuit board, and the circuit board body is spaced from the first circuit board, and the fixation portion is fixed to the first circuit board. The case is provided with an avoidance groove penetrating therethrough along a direction perpendicular to the optical axis direction, and the flexible extension portion passes through the avoidance groove to be electrically connected to an external circuit.

As an improvement, the driving coil assembly includes a coil substrate stacked and fixed to the first circuit board, and a driving coil fixed to a side of the coil substrate facing the magnet assembly.

As an improvement, the magnet assembly works together with the driving coil assembly to drive the image sensor to move along a first direction and a second direction that are perpendicular to the optical axis direction, and the first direction is perpendicular to the second direction; and the lens driving device further includes an anti-collision assembly fixed to the first circuit board, the anti-collision assembly includes a first anti-collision block fixed to each of two opposite sides of the first circuit board along the first direction, and a second anti-collision block fixed to each of two opposite sides of the first circuit board along the second direction.

As an improvement, the lens driving device further includes a connection member, two ends of the connection member are fixed to the first anti-collision block and the second anti-collision block.

As an improvement, the case includes a bottom lid and an upper lid that coves and is fixed to the bottom lid; the elastic bracket includes a bracket body provided at an inner side of the upper lid, and a first mounting portion and a second mounting portion extending from two ends of the bracket body towards the circuit board assembly; and the circuit board assembly is fixed to the first mounting portion, the second mounting portion is fixed to the bottom lid, and the magnet assembly is fixed to the upper lid.

As an improvement, the first anti-collision block is provided with a first limiting groove recessed from a side of the first anti-collision block adjacent to the upper lid towards a direction away from the upper lid, and the second anti-collision block is provided with a second limiting groove recessed from a side of the second anti-collision block adjacent to the upper lid towards a direction away from the upper lid. The upper lid includes an upper lid body formed as a rectangular frame, and a support portion extending from an end of the upper lid body away from the bottom lid; and the support portion encloses the opening, and the upper lid further includes a first damping portion and a second damping portion bent and extending from an inner edge of the support portion towards the bottom lid. The first damping portion extends into the first limiting groove, and the second damping portion extends into the second limiting groove.

As an improvement, a width of the first damping portion in a direction parallel to the first direction is the same as a width of the first damping portion in a direction parallel to the second direction; and a width of the second damping portion in the direction parallel to the first direction is the same as a width of the second damping portion in the direction parallel to the second direction.

As an improvement, the first circuit board is provided with a through hole penetrating therethrough along the optical axis direction, the lens driving device further includes a sensor bracket that is fixed to the first circuit board and covers the through hole, and the image sensor is fixed to a side of the sensor bracket facing the opening and is arranged in the through hole.

Compared with the solutions in the related art, for the lens driving device provided by the present disclosure: the driving coil assembly and the magnet assembly are fixed to the circuit board assembly and the case, respectively, the driving coil assembly is spaced from the magnet assembly, the case is provided with an opening penetrating therethrough along the optical axis direction of the image sensor, and the image sensor is arranged opposite to the opening along the optical axis direction; the magnet assembly and the driving coil assembly are arranged opposite to each other along the optical axis direction to drive the image sensor to move relative to the case along the direction perpendicular to the optical axis direction; the circuit board assembly includes a first circuit board stacked and fixed to a side of the elastic bracket and a second circuit board connected to the first circuit board; the driving coil assembly is fixed to a side of the first circuit board facing the magnet assembly; the first circuit board is electrically connected to an external circuit by means of the second circuit board; the first circuit board is a PCB circuit board, and the second circuit board is an FPC circuit board; a stacking height of the circuit board assembly is further reduced by means of a soft-hard combination of the first circuit board and the second circuit board; the first circuit board and the second circuit board are formed as an integral structure, thereby reducing the soldering between the first circuit board and the second circuit board, which can save the stacking height in the optical axis direction during soldering, thus reducing an overall stacking height and maximizing the use of the mounting space.

### BRIEF DESCRIPTION OF DRAWINGS

In order to better illustrate the technical solutions in embodiments of the present disclosure, the drawings required to be used in the description of the embodiments will be briefly described below. It is appreciated that, the drawings in the following description merely illustrate some embodiments of the present disclosure, and for those skilled in the art, other drawings can be obtained according to these accompanying drawings without creative effort.

FIG. 1 is a perspective view of a lens driving device according to an embodiment of the present disclosure;

FIG. 2 is a partial structural exploded view of a lens driving device according to an embodiment of the present disclosure;

FIG. 3 is a perspective structural exploded view of a lens driving device according to an embodiment of the present disclosure;

FIG. 4 is a sectional view along A-A shown in FIG. 1;

FIG. 5 is a sectional view along B-B shown in FIG. 1;

FIG. 6 is a top view of an anti-collision assembly according to an embodiment of the present disclosure; and

FIG. 7 is a schematic diagram of a circuit board assembly according to an embodiment of the present disclosure.

### REFERENCE SIGNS

100. lens driving device;
1. case;
101. bottom lid;
102. upper lid;
1021. upper lid body;
1022. support portion;
1023. first damping portion;
1024. second damping portion;
1025. opening;
1026. aperture;
1027. avoidance groove;
2. elastic bracket;
21. bracket body;
22. first mounting portion;
23. second mounting portion;
3. circuit board assembly;
31. first circuit board;
311. through hole;
32. second circuit board;
321. circuit board body;
322. flexible extension portion;
323. connection portion;
324. fixation portion;
4. driving coil assembly;
41. coil substrate;
42. driving coil;
421. first coil set;
422. second coil set;
5. magnet assembly;
51. first magnet unit;
52. second magnet unit;
6. first magnetic conductive sheet;
7. second magnetic conductive sheet;
8. frame;
9. anti-collision assembly;
91. first anti-collision block;
911. first limiting groove;
92. second anti-collision block;
921. second limiting groove;
93. connection member;
10. image sensor;
11. first driving chip;
12. second driving chip;
13. optical filter;
14. sensor bracket.

### DESCRIPTION OF EMBODIMENTS

The technical solutions in the embodiments of the present disclosure are described in the following with reference to the accompanying drawings. It should be noted that, the described embodiments are merely exemplary embodiments of the present disclosure, which shall not be interpreted as providing limitations to the present disclosure. All other embodiments obtained by those skilled in the art without creative efforts according to the embodiments of the present disclosure shall fall within a scope of the present disclosure.

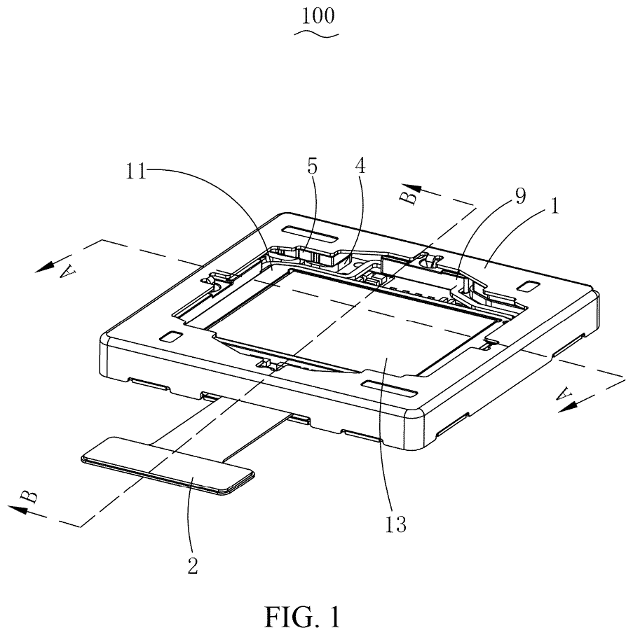

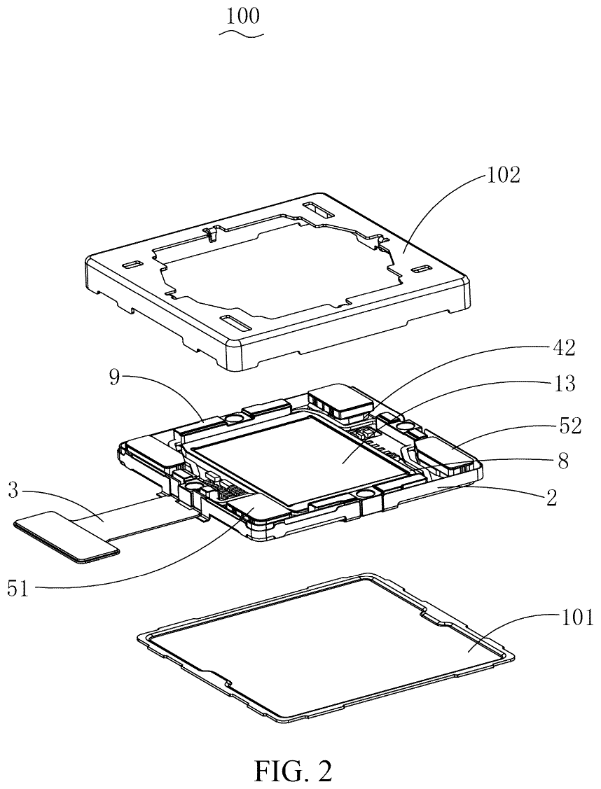

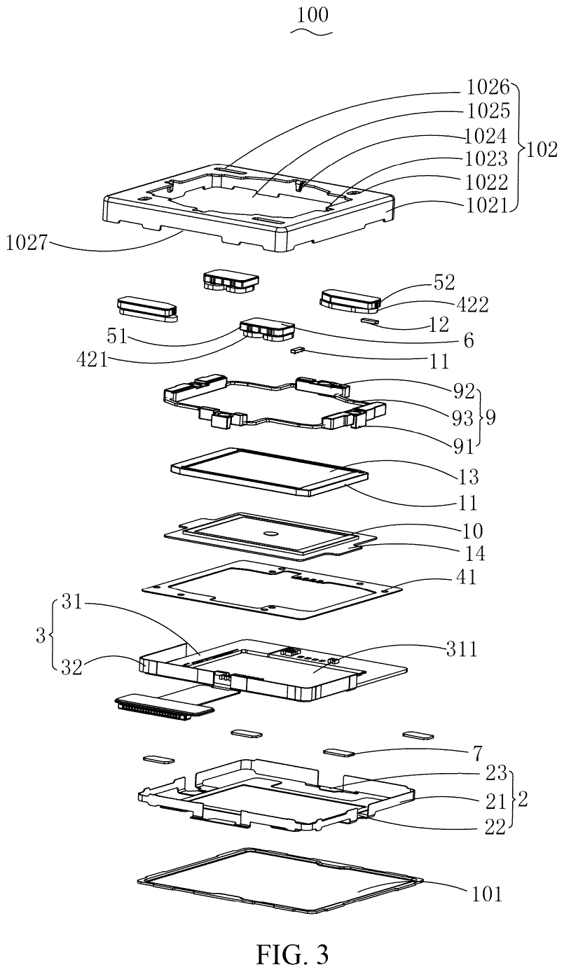

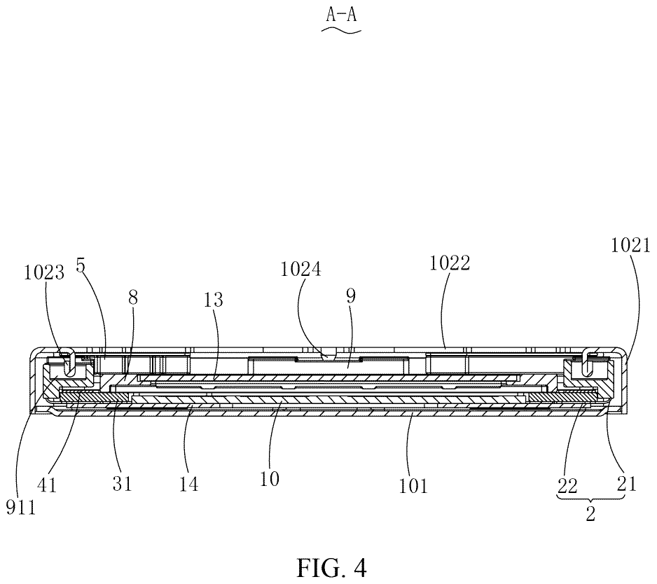

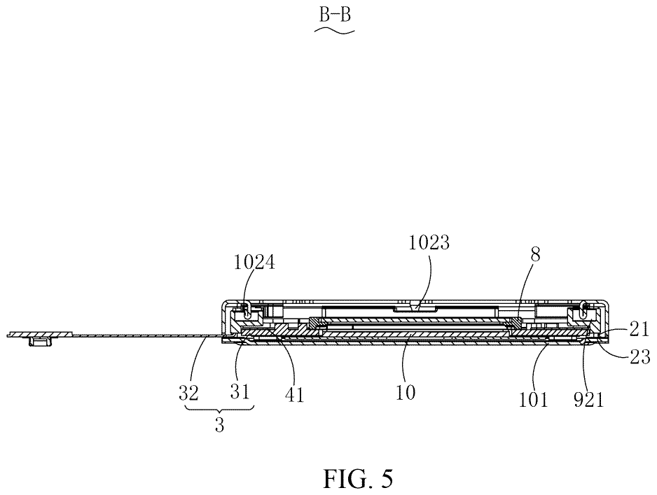

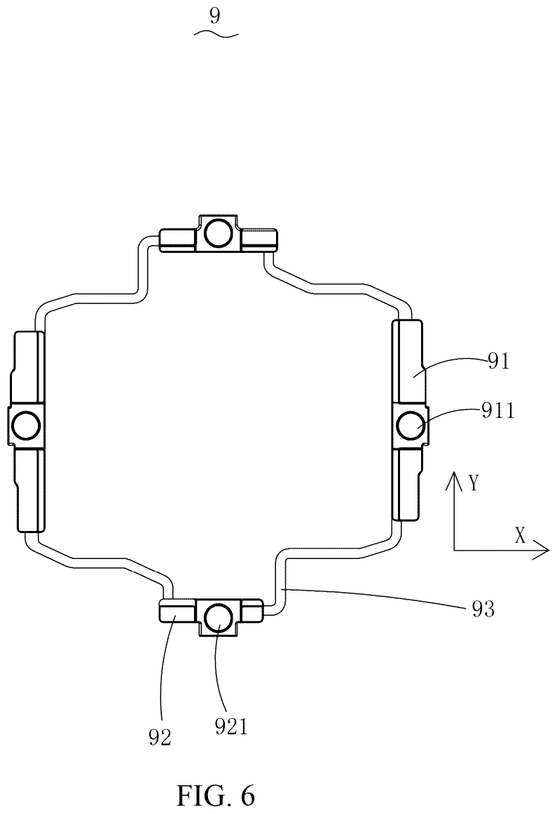

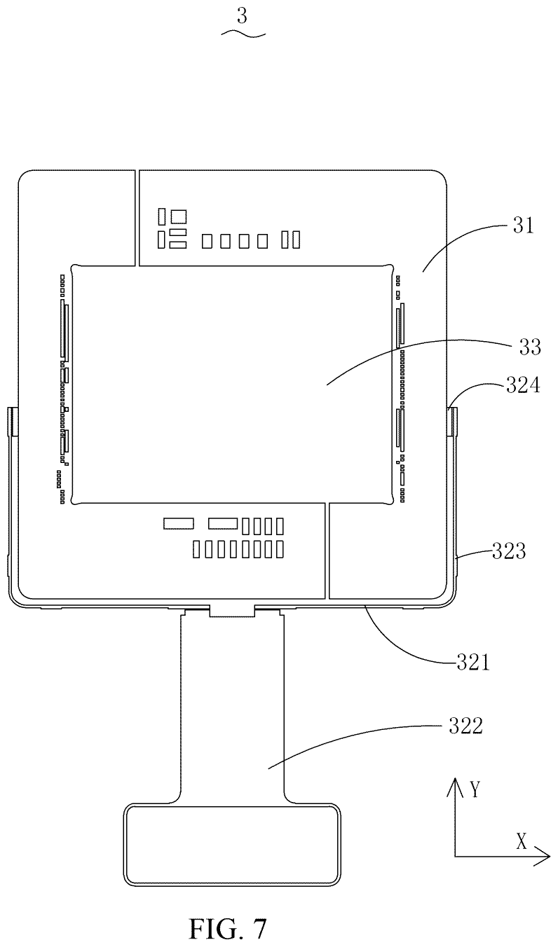

As shown in FIG. 1 to FIG. 7, an embodiment of the present disclosure provides a lens driving device 100, including: a case 1, a magnet assembly 5 fixed to the case 1, a circuit board assembly 3 suspended in the case 1, an elastic bracket 2 for supporting the circuit board assembly 3 at the case 1, a driving coil assembly 4 stacked and fixed to the circuit board assembly 3 and electrically connected to the circuit board assembly 3, and an image sensor 10 fixed to the circuit board assembly 3. The case 1 is provided with an opening 1025 penetrating through the case 1 along an optical axis direction of the image sensor 10. The image sensor 10 is opposite to the opening 1025 along the optical axis direction. The driving coil assembly 4 is spaced from the magnet assembly 5. The magnet assembly 5 and the driving coil assembly 4 are opposite to each other along the optical axis direction to drive the image sensor 10 to move relative to the case along a direction perpendicular to the optical axis direction.

In an example, the lens driving device 100 further includes a frame 8 and an optical filter 13. The frame 8 is opposite to the opening 1025 and is fixed to the circuit board assembly 3, and the optical filter 13 is mounted and fixed to the frame 8.

The circuit board assembly 3 includes a first circuit board 31 stacked and fixed to the elastic bracket 2, and a second circuit board 32 connected to the first circuit board 31. The driving coil assembly 4 is fixed to a side of the first circuit board 31 facing the magnet assembly 5. The first circuit board 31 is electrically connected to an external circuit by means of the second circuit board 32. The first circuit board 31 and the second circuit board 32 are formed as an integral structure, to reduce the soldering between the first circuit board 31 and the second circuit board 32, which can save the stacking height in the optical axis direction during soldering, thereby reducing an overall stacking height and maximizing the use of the mounting space. The first circuit board 31 is a PCB circuit board, which is a hard circuit board with a high structural strength and a good supporting effect. The second circuit board 32 is an FPC circuit board, which is flexible, light and thin, and saves a stacking height in the optical axis direction. Therefore, the stacking height of the circuit board assembly 3 is further reduced by means of the soft-hard combination of the first circuit board 31 and the second circuit board 32.

In an example, the second circuit board 32 is connected to a peripheral side of the first circuit board 31, and the first circuit board 31 and the second circuit board 32 do not overlap with each other in an optical axis direction of the image sensor 10, so that the circuit board assembly 3 has a smaller stacking height.

In an embodiment of the present disclosure, a thickness of the first circuit board 31 is greater than a thickness of the second circuit board 32. As a result, the first circuit board 31 has high structural strength and good supporting performance.

In an embodiment of the present disclosure, the second circuit board 32 includes a circuit board body 321, a flexible extension portion 322 extending from a side of the circuit board body 321 away from the first circuit board 31, a connection portion 323 bent and extending from two opposite ends of the circuit board body 321 towards the first circuit board, and a fixation portion 324 bent and extending from the connection portion 323 towards the first circuit board. The circuit board body 321 is spaced from the first circuit board 31, and the fixation portion 324 is fixed to the first circuit board 321. The case 1 is provided with an avoidance groove 1027 penetrating therethrough along a direction perpendicular to the optical axis direction, and the flexible extension portion 322 passes through the avoidance groove 1027 to be electrically connected to an external circuit, so as to provide power to the driving coil assembly 4 by means of the flexible extension portion 1027.

In an embodiment of the present disclosure, the driving coil assembly 4 includes a coil substrate 41 stacked and fixed to the first circuit board 31, and a driving coil 42 fixed to a side of the coil substrate 41 facing the magnet assembly.

In an embodiment of the present disclosure, the magnet assembly 5 works together with the driving coil assembly 4 to drive the image sensor 10 to move along a first direction X perpendicular to the optical axis direction and along a second direction Y perpendicular to the optical axis direction, the first direction X being perpendicular to the second direction Y.

The lens driving device 100 further includes an anti-collision assembly 9 fixed to the first circuit board. The anti-collision assembly 9 includes first anti-collision blocks 91 respectively fixed to two opposite sides of the first circuit board 31 along the first direction X, and second anti-collision blocks 92 respectively fixed to two opposite sides of the first circuit board 31 along the second direction Y. The first anti-collision blocks 91 and the second anti-collision blocks 92 can prevent the circuit board assembly 3 from colliding with the case 1 when carrying the image sensor 10 to move, thereby improving movement stability; and also can limit a rotation position of the frame 8, to prevent the image sensor 10 from rotating excessively, thereby improving safety.

In an embodiment of the present disclosure, the lens driving device 100 further includes a connection member 93, and two ends of the connection member 93 respectively fix the first anti-collision block 91 and the second anti-collision block 92. The stability of the first anti-collision block 91 and the second anti-collision block 92 can be increased by providing the connection member 93. It can be understood that, four connection members 93 are provided, and a respective one connection member 93 is arranged between a pair of adjacent first anti-collision block 91 and second anti-collision block 92.

In an embodiment of the present disclosure, the case 1 includes a bottom lid 101 and an upper lid 102 that covers and is fixed to the bottom lid 101. The elastic bracket 2 includes a bracket body 21 provided at an inner side of the upper lid 102, and a first mounting portion 22 and a second mounting portion 23 extending from two ends of the bracket body 21 towards the circuit board assembly 3. The circuit board assembly 3 is fixed to the first mounting portion 22, and the second mounting portion 23 is fixed to the bottom lid 101. The magnet assembly 5 is fixed to the upper lid 102. The opening 1025 is formed at the upper lid 102.

In an embodiment of the present disclosure, the first anti-collision block 91 is provided with a first limiting groove 911 recessed from a side of the first anti-collision block 91 adjacent to the upper lid 102 towards a direction away from the upper lid 102, and the second anti-collision block 92 is provided with a second limiting groove 921 recessed from a side of the second anti-collision block 92 adjacent to the upper lid 102 towards a direction away from the upper lid 102. The upper lid 102 includes an upper lid body 1021 formed as a rectangular frame, and a support portion 1022 extending from a side of the upper lid body 1021 away from the bottom lid 101 towards an inner peripheral side thereof. The support portion 1022 encloses the opening, and the upper lid 102 further includes a first damping portion 1023 and a second damping portion 1024 bent and extending from an inner peripheral edge of the support portion 1022 towards the bottom lid 101. The first damping portion 1023 and the second damping portion 1024 are arranged in the first limiting groove 911 and the second limiting groove 921, respectively. The avoidance groove 1027 is formed by penetrating therethrough at a side of the upper lid body 1021.

In an embodiment of the present disclosure, the first damping portion 1023 and the second damping portion 1024 have a same structure. A width of a side of the first damping portion 1023 parallel to the first direction X is the same as a width of a side of the first damping portion 1023 parallel to the second direction Y. A width of a side of the second damping portion 1024 parallel to the first direction X is the same as a width of a side of the second damping portion 1024 parallel to the second direction Y. The first direction X and the second direction Y are perpendicular to each other and are both perpendicular to the optical axis direction. The first damping portion 1023 and the second damping portion 1024 adopt a stamped stacked structure, and each have a same size in the thickness direction and in the width direction, so that the damping effect perpendicular to the optical axis direction can be consistent, and the damping effect is good.

In an embodiment of the present disclosure, the driving coil assembly 4 includes a first coil set 421 and a second coil set 422 spaced from each other. The first coil set 421 is arranged along a diagonal line of the circuit board assembly 3, and the second coil set 422 is arranged along another diagonal line of the circuit board assembly 3. The magnet assembly 5 includes a first magnet unit 51 spaced from the first coil set 421, and a second magnet unit 52 spaced from the second coil set 422. The first magnet unit 51 is a Halbach magnetic circuit. The first coil set 421 works together with the first magnet unit 51 to drive the circuit board assembly 3 to move along the first direction X when carrying the image sensor 10, and the second coil set 422 interacts with the second magnet unit 52 to drive the circuit board assembly 3 to move along the second direction Y when carrying the image sensor 10.

In an embodiment of the present disclosure, the first coil set 421 and the second coil set 422 are arranged at four corners of the circuit board assembly 3, such that the first magnet unit 51 and the second magnet unit 52 also correspond to the four corners of the circuit board assembly 3. The arrangement of the coils and the magnets enhances the overall driving force of the lens driving device 100, while saving the mounting space.

In an embodiment of the present disclosure, the lens driving device 100 further includes a first driving chip 11 and a second driving chip 12. The first driving chip 11 is arranged in the first coil set 421 and configured to control the first coil set 421 to work together with the magnet assembly 5 to move along the first direction X. The second driving chip 12 is arranged in the second coil set 422 and configured to control the second coil set 422 to work together with the magnet assembly 5 to move along the second direction Y.

In an embodiment of the present disclosure, the lens driving device 100 further includes a first magnetic conductive sheet 6 that is stacked and fixed to a side of the magnet assembly 5 away from the driving coil assembly 4. The case is provided with an aperture 1026 penetrating therethrough, and the first magnetic conductive sheet is arranged in the aperture 1026. The magnetic conductive effect of the magnet assembly 5 is improved by means of the first magnetic conduction sheet 6.

In an embodiment of the present disclosure, the lens driving device 100 further includes a second magnetic conductive sheet 7 that is fixed to the case 1. The second magnetic conductive sheet 7 is arranged at a side of the driving coil assembly 4 away from the magnet assembly 5, and the second magnetic conductive sheet 7 is arranged opposite to the magnet assembly 5, thereby improving the magnetic conductive effect.

In an embodiment of the present disclosure, the first circuit board 31 is provided with a through hole 311 penetrating therethrough along the optical axis direction. The lens driving device 100 further includes a sensor bracket 14 that is fixed to the first circuit board 31 and covers the through hole 311. The image sensor 10 is fixed to a side of the sensor bracket 14 facing the opening 1025 and is arranged in the through hole 311.

Compared with the solutions in the related art, for the lens driving device provided by the present disclosure: the driving coil assembly and the magnet assembly are fixed to the circuit board assembly and the case, respectively, the driving coil assembly is spaced from the magnet assembly, the case is provided with an opening penetrating therethrough along the optical axis direction of the image sensor, and the image sensor is arranged opposite to the opening along the optical axis direction; the magnet assembly and the driving coil assembly are arranged opposite to each other along the optical axis direction to drive the image sensor to move relative to the case along the direction perpendicular to the optical axis direction; the circuit board assembly includes a first circuit board stacked and fixed to a side of the elastic bracket and a second circuit board connected to the first circuit board; the driving coil assembly is fixed to a side of the first circuit board facing the magnet assembly; the first circuit board is electrically connected to an external circuit by means of the second circuit board; the first circuit board is a PCB circuit board, and the second circuit board is an FPC circuit board; a stacking height of the circuit board assembly is further reduced by means of a soft-hard combination of the first circuit board and the second circuit board; the first circuit board and the second circuit board are formed as an integral structure, thereby reducing the soldering between the first circuit board and the second circuit board, which can save the stacking height in the optical axis direction during soldering, thus reducing an overall stacking height and maximizing the use of the mounting space.

The above description merely illustrates some embodiments of the present disclosure. It should be noted that those skilled in the art may make improvements without departing from a creative concept of the present disclosure, but all these improvements shall fall within a scope of the present disclosure.

What is claimed is:

1. A lens driving device, comprising:
a case;
a magnet assembly fixed to the case;
a circuit board assembly suspended in the case;
an elastic bracket supporting the circuit board assembly at the case;
a driving coil assembly stacked and fixed to the circuit board assembly and electrically connected to the circuit board assembly; and
an image sensor fixed to the circuit board assembly,
wherein the case is provided with an opening penetrating through the case along an optical axis direction of the image sensor, the image sensor is opposite to the opening along the optical axis direction, and the magnet assembly and the driving coil assembly are opposite to each other along the optical axis direction, to drive the image sensor to move relative to the case along a direction perpendicular to the optical axis direction;
wherein the circuit board assembly comprises a first circuit board stacked and fixed to the elastic bracket, and a second circuit board connected to the first circuit board, the driving coil assembly is fixed to a side of the first circuit board facing the magnet assembly, and the first circuit board is electrically connected to an external circuit by means of the second circuit board; and
wherein the first circuit board is a printed circuit board (PCB), the second circuit board is a flexible circuit board (FPC), and the first circuit board and the second circuit board are formed as an integral structure.

2. The lens driving device as described in claim 1, wherein a thickness of the first circuit board is greater than a thickness of the second circuit board.

3. The lens driving device as described in claim 1,
wherein the second circuit board comprises a circuit board body, a flexible extension portion extending from a side of the circuit board body away from the first circuit board, a connection portion bent and extending from two opposite ends of the circuit board body towards the first circuit board, and a fixation portion bent and extending from the connection portion towards the first circuit board, and wherein the circuit board body is spaced from the first circuit board, and the fixation portion is fixed to the first circuit board; and
wherein the case is provided with an avoidance groove penetrating therethrough along a direction perpendicular to the optical axis direction, and the flexible extension portion passes through the avoidance groove to be electrically connected to an external circuit.

4. The lens driving device as described in claim 1, wherein the driving coil assembly comprises a coil substrate stacked and fixed to the first circuit board, and a driving coil fixed to a side of the coil substrate facing the magnet assembly.

5. The lens driving device as described in claim 1, wherein the magnet assembly works together with the driving coil assembly to drive the image sensor to move along a first direction and a second direction that are perpendicular to the optical axis direction, and the first direction is perpendicular to the second direction; and wherein the lens driving device further comprises an anti-collision assembly fixed to the first circuit board, the anti-collision assembly comprises a first anti-collision block fixed to each of two opposite sides of the first circuit board along the first direction, and a second anti-collision block fixed to each of two opposite sides of the first circuit board along the second direction.

6. The lens driving device as described in claim 5, further comprising a connection member, wherein two ends of the connection member are fixed to the first anti-collision block and the second anti-collision block.

7. The lens driving device as described in claim 6, wherein the case comprises a bottom lid and an upper lid that coves and is fixed to the bottom lid; the elastic bracket comprises a bracket body provided at an inner side of the upper lid, and a first mounting portion and a second mounting portion extending from two ends of the bracket body towards the circuit board assembly; and the circuit board assembly is fixed to the first mounting portion, the second mounting portion is fixed to the bottom lid, and the magnet assembly is fixed to the upper lid.

8. The lens driving device as described in claim 7,
wherein the first anti-collision block is provided with a first limiting groove recessed from a side of the first anti-collision block adjacent to the upper lid towards a direction away from the upper lid, and the second anti-collision block is provided with a second limiting groove recessed from a side of the second anti-collision block adjacent to the upper lid towards a direction away from the upper lid;
wherein the upper lid comprises an upper lid body formed as a rectangular frame, and a support portion extending from an end of the upper lid body away from the bottom lid; and the support portion encloses the opening, and the upper lid further comprises a first damping portion and a second damping portion bent and extending from an inner edge of the support portion towards the bottom lid; and
wherein the first damping portion extends into the first limiting groove, and the second damping portion extends into the second limiting groove.

9. The lens driving device as described in claim 8, wherein a width of the first damping portion in a direction parallel to the first direction is the same as a width of the first damping portion in a direction parallel to the second direction; and a width of the second damping portion in the direction parallel to the first direction is the same as a width of the second damping portion in the direction parallel to the second direction.

10. The lens driving device as described in claim 1, wherein the first circuit board is provided with a through hole penetrating therethrough along the optical axis direction, the lens driving device further comprises a sensor bracket that is fixed to the first circuit board and covers the through hole, and the image sensor is fixed to a side of the sensor bracket facing the opening and is arranged in the through hole.
